(19) United States
(12) Patent Application Publication
(10) Pub. No.: US 2011/0108564 A1
(43) Pub. Date: May 12, 2011

(54) PRODUCT DISPENSING METHOD AND VENDING MACHINE

(75) Inventor: Aristide Roncari, Paderno Dugnano (IT)

(73) Assignee: N&W GLOBAL VENDING S.P.A., Valbrembo (IT)

(21) Appl. No.: 12/934,565

(22) PCT Filed: Mar. 25, 2009
(86) PCT No.: PCT/IB09/00587

§ 371 Date: Jan. 19, 2011

(30) Foreign Application Priority Data
Mar. 26, 2008 (IT) TO2008A000228

(51) Int. Cl. G07F 11/16; B65D 83/00; G07F 11/38

(52) U.S. Cl. 221/1; 221/98; 221/99

(57) ABSTRACT

A dispensing method and vending machine (1) for products (2), whereby a drawer (7), defining a pickup compartment (8) for a selected product (2) in the vending machine (1), is maintained by a first force (F1) in a stable closed position to receive the selected product (2), and is then moved into an open position, in which the pickup compartment (8) is accessible from outside the vending machine (1), by imparting a work movement to an actuator (24), which simply moves into contact with the drawer (7) to exert on the drawer (7) a second force (F2) in opposition to and greater than the first force (F1).

### TECHNICAL FIELD

The present invention relates to a product dispensing method and vending machine.

### BACKGROUND ART

Product vending machines comprise a cabinet or similar container defining a compartment, which is closed at the front by a front wall defined at least partly by a door normally made at least partly of transparent material. The cabinet is normally fitted inside with fixed, superimposed trays for supporting respective numbers of products, such as bottles, tins, boxes or bags, arranged in rows perpendicular to the door. The trays occupy a rear portion of the compartment, so as to define, between the front ends of the trays and the door, a drop shaft communicating with a pickup compartment normally housed in the bottom of the cabinet or along a column forming part of the front wall and to the side of the door.

Each row is normally engaged by a respective conveyor, normally a push conveyor, which is activated selectively by the user to feed the relative products successively to the drop shaft, along which the selected products are fed, simply by gravity or by means of a transfer device, into the pickup compartment.

Some known vending machines are equipped with a pickup device defined by a hatch, which closes the front of the pickup compartment, is located on the front wall of the cabinet, is normally equipped with an automatic locking device, and, when opened, allows the user to remove the selected product/s from the pickup compartment.

Mainly to prevent break-ins, the above known pickup device is normally waived in favour of a “drawer” type pickup device, which comprises a drawer defining the pickup compartment and which can at least partly be pulled out manually through an opening in the front wall of the cabinet, so the pickup compartment is accessible from the outside.

Known drawer-type pickup devices have the drawback of sometimes making the selected product/s awkward to remove, especially when, for various reasons, the user is forced to open the drawer and remove the selected product/s one-handedly.

### DISCLOSURE OF INVENTION

It is an object of the present invention to provide a product vending machine dispensing method that is cheap and easy to implement and, at the same time, provides for partly solving and possibly eliminating the above drawback.

According to the present invention, there is provided a product vending machine dispensing method as claimed in Claim 1 and preferably in any one of the following Claims depending directly or indirectly on Claim 1.

According to the present invention, there is also provided a product vending machine as claimed in Claim and preferably in any one of the following Claims depending directly or indirectly on claim 13.

### BRIEF DESCRIPTION OF THE DRAWINGS

A non-limiting embodiment of the present invention will be described by way of example with reference to the accompanying drawings, in which:

FIG. 1 shows a schematic view in perspective of a preferred embodiment of the vending machine according to the present invention;

FIG. 2 shows a larger-scale, partly sectioned side view, with parts removed for clarity, of a pickup device forming part of the FIG. 1 vending machine;

FIG. 3 shows a larger-scale, rear view in perspective, partly in block form, of a first detail of FIG. 2;

FIG. 4 shows a larger-scale front view in perspective of a second detail of FIG. 2;

FIG. 5 shows a larger-scale side view in perspective of a third detail of FIG. 2;

FIGS. 6 to 8 show partly sectioned side views, with parts removed for clarity, of the FIG. 4 detail in respective operating positions;

FIGS. 9 to 12 show partly sectioned side views, with parts removed for clarity, of the FIG. 4 detail in respective operating positions.

### BEST MODE FOR CARRYING OUT THE INVENTION

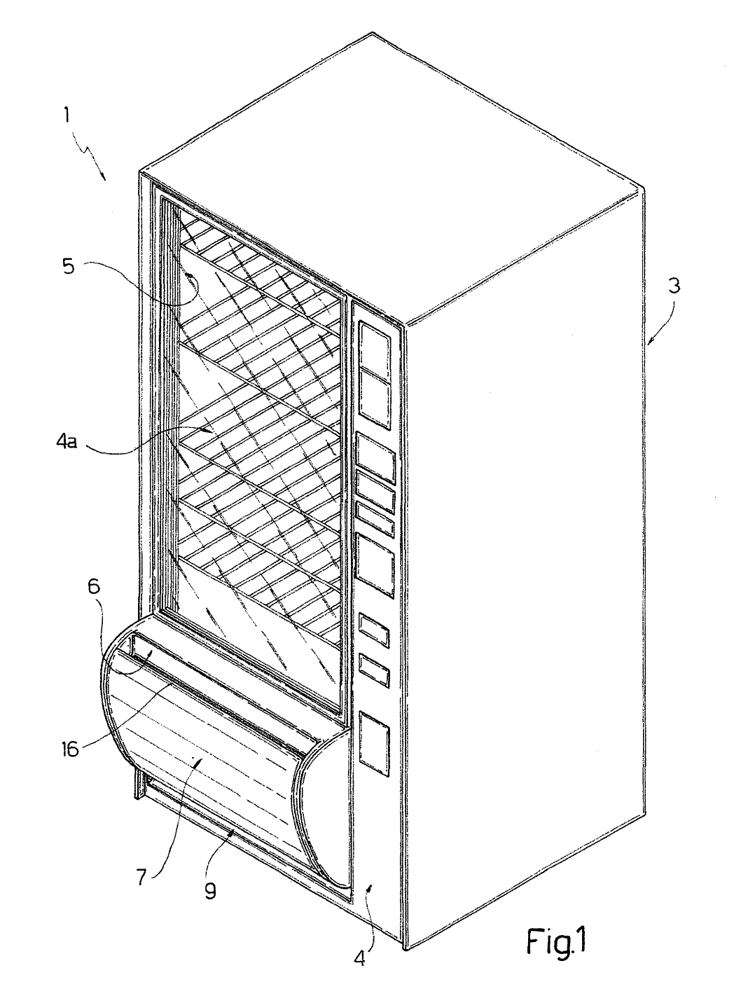

Number 1 in FIG. 1 indicates as a whole a vending machine for products 2, which comprises a cabinet 3 having a wall 4 defining the front of an inner compartment 5 housing a number of superimposed trays for supporting products 2, which are arranged on the relative trays in rows perpendicular to wall 4 and facing an opening formed through a top portion of wall 4 and closed by a door 4a. Below door 4a, wall 4 comprises a bottom portion having an opening 6, through which is fitted movably a drawer 7 defining a pickup compartment 8 of a pickup device 9, which allows the user to remove from the outside a selected product 2 fed into pickup compartment 8 by a known feed device (not shown) housed inside a gap, which extends between the front ends of the trays and door 4a, is closed at the bottom by drawer when this is in its normal closed position, and communicates directly with the pickup compartment when drawer 7 is in its normal closed position.

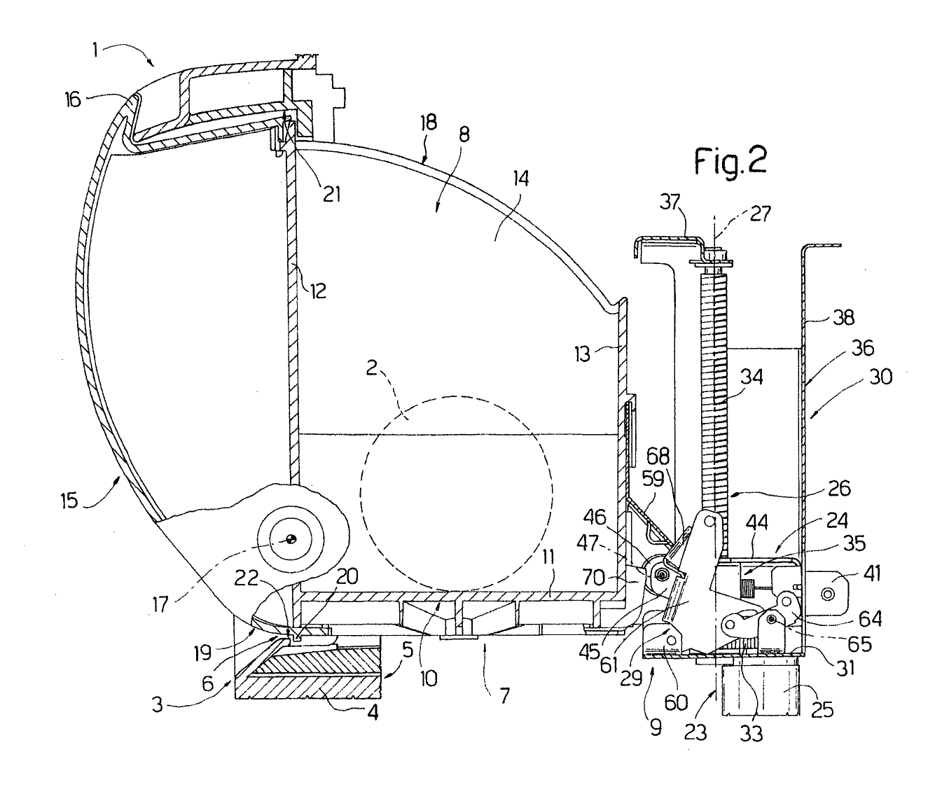

As shown in FIG. 2, drawer 7 comprises a cup-shaped body 10 bounded by a rectangular bottom box wall 11, by a rectangular front wall 12 and a rectangular rear wall 13 parallel to each other and perpendicular to bottom wall 11, and by two parallel lateral walls 14 perpendicular to bottom wall 11 and walls 12 and 13. Drawer 7 also comprises a box body 15 connected to the outer surface of wall 12 and defining a handle 16 of drawer 7.

Drawer 7 is fitted to wall 4 to rotate with respect to wall 4 about an axis 17 parallel to walls 11, 12 and and extending through walls 14, close to the edge between wall 12 and wall 11. Wall 12 is higher than wall 13; each wall 14 is bounded at its free end by a curved edge 18 coaxial with axis 17; and box body 15 is bounded externally, close to where it is connected to wall 11, by a curved surface 19 coaxial with axis 17 and bounded, on the side facing cabinet 3, by a rib 20 parallel to axis 17.

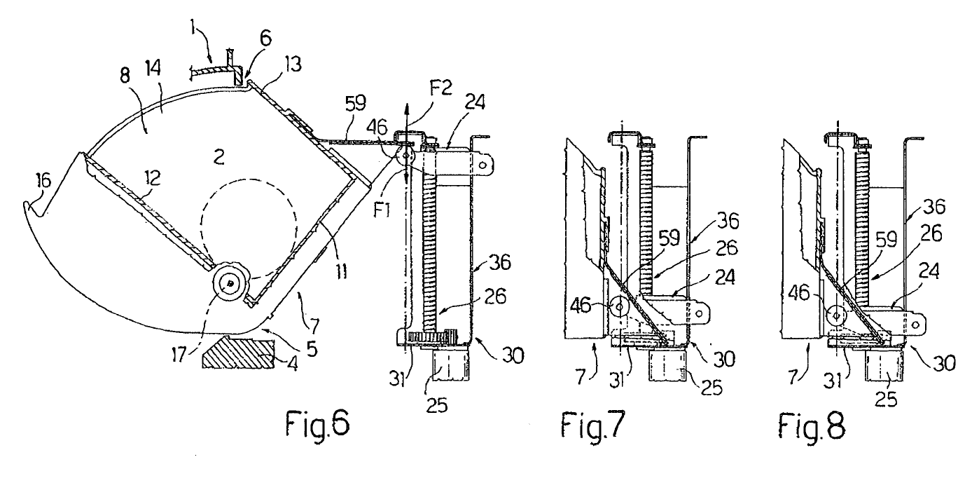

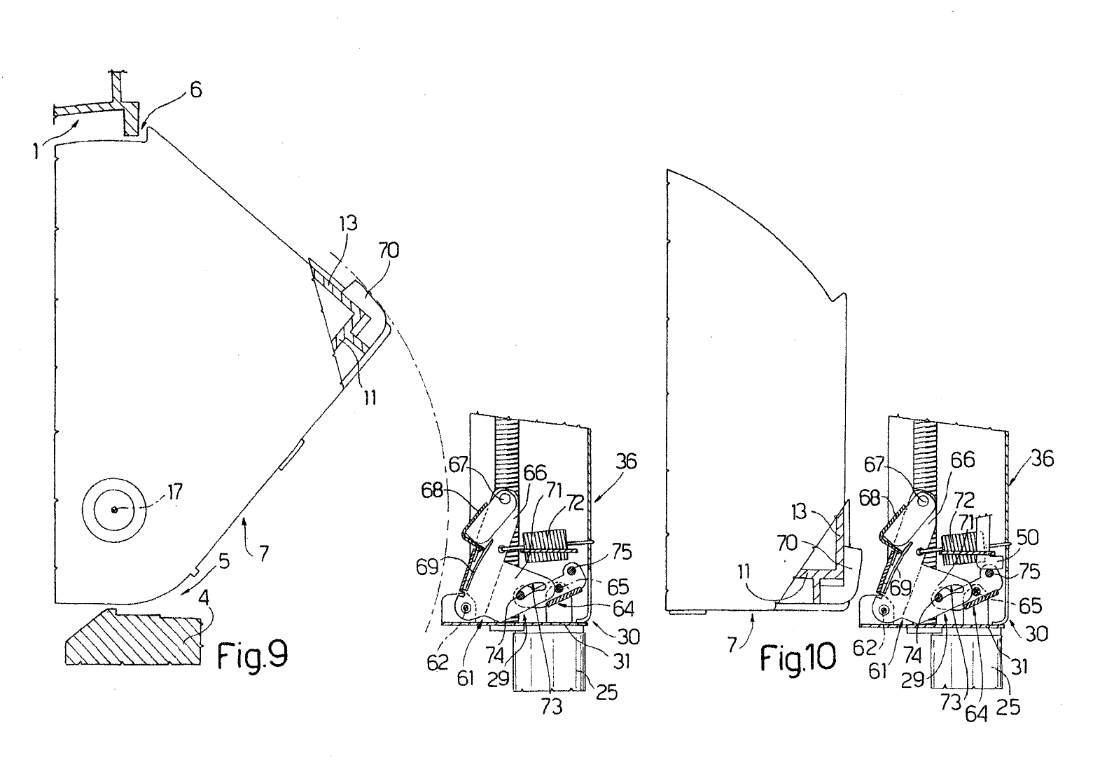

Drawer 7 swings about axis 17 between a closed position (FIGS. 2, 3, 5, 7, 8, 10, 11), in which wall 11 is horizontal, cup-shaped body 10 is positioned with its concavity facing upwards to receive a selected product 2 fed downwards in known manner, box body 10 projects outwards of wall 4, and rib 20 is positioned substantially contacting an inner surface of wall 4; and an open position (FIGS. 6, 9), in which walls 11 and 12 form an upward-facing dihedron open outwardly at the top to retain product 2, and walls 11 and 13 form a dihedron with its vertex facing the inside of cabinet 3, and its concavity facing outwards, and completely close opening 6 to prevent break-in when drawer 7 is open. As drawer 7 swings between the open and closed positions, curved edges 18 move substantially in contact with a top edge 21 of opening 6, and curved surface 19 moves substantially in contact with a bottom edge 22 of opening 6.

The weight of drawer 7 is distributed about axis 17 so that drawer 7 is subjected at all times to a force—shown schematically by F1—that tends to keep drawer 7 in or restore it to a stable, balanced closed position. Alternatively, force F1 is generated both by the weight distribution of drawer 7 and by springs (not shown) interposed between cabinet 3 and drawer 7, or by the springs (not shown) alone.

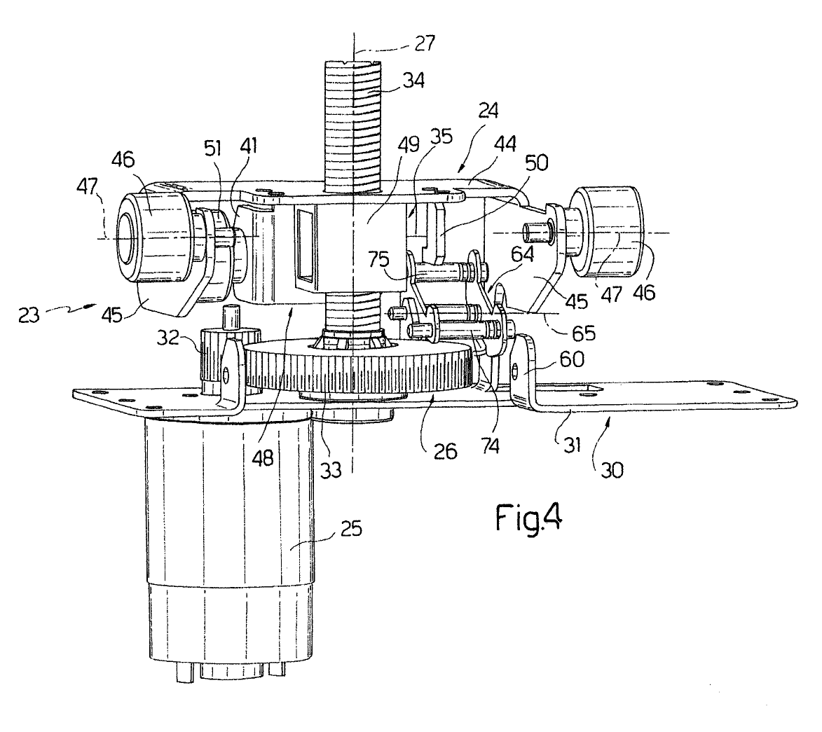

As shown in FIG. 4, in addition to drawer 7, pickup device 9 comprises an actuating device 23, in turn comprising an actuator 24, and a reversible motor 25 connected to actuator 24 by a transmission 26 to move actuator 24 along a vertical axis 27 and engage drawer 7 to exert a force F2, in opposition to and greater than force F1, on drawer 7 to move it into the open position.

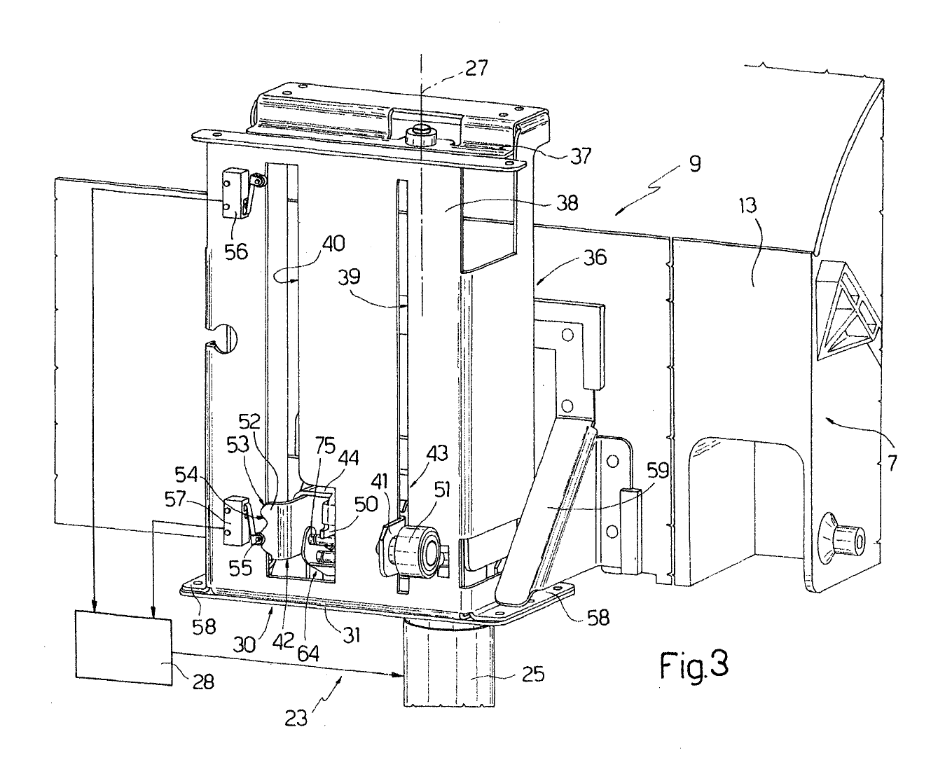

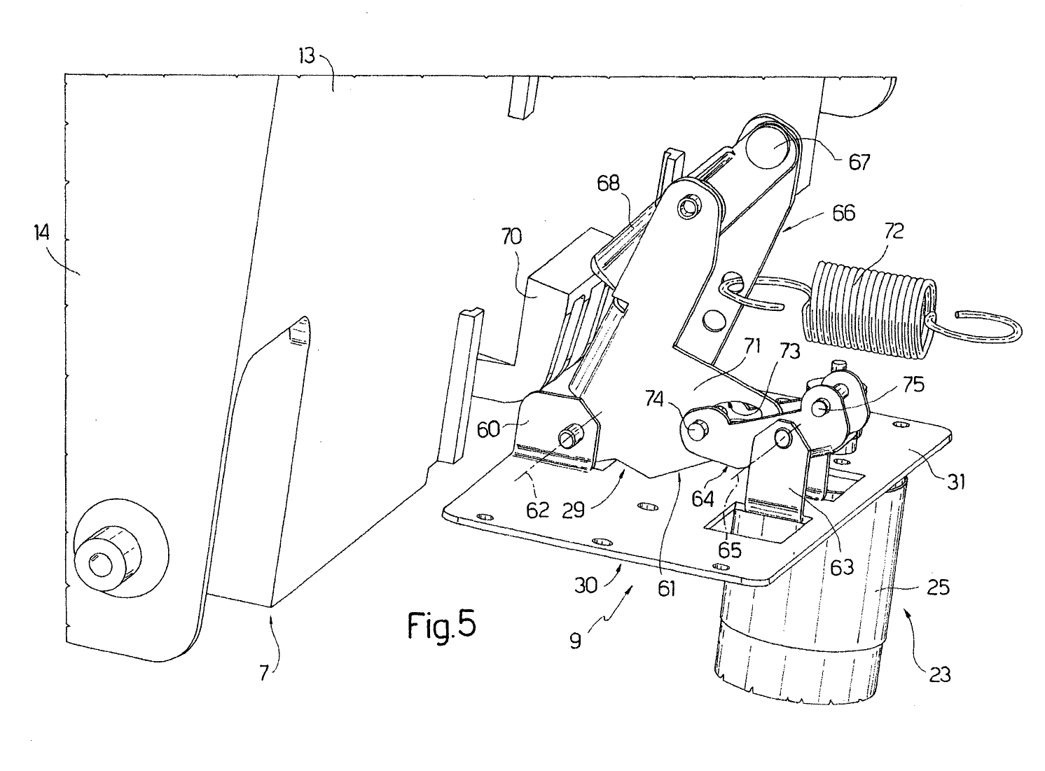

Pickup device 9 also comprises a central control unit 28 (FIG. 3) for controlling motor 25; and a lock device 29 (FIGS. 3, 5) operated by motor 25 by means of actuator 24 to lock drawer 7 releasably in the closed position.

As shown in FIG. 4, actuating device 23 is fitted to a fixed casing 30 comprising a horizontal plate 31 supporting motor 25 underneath and fitted through with a vertical output pinion 32 of motor 25. Pinion 32 meshes with a gear 33, which is fitted in rotary manner to plate 31, is coaxial with axis 27, forms part of transmission 26, and is fitted to a screw 34, which is coaxial with axis 27, is fitted to actuator 24 by a screw-nut screw coupling 35, and defines a straight path for actuator 24.

As shown in FIG. 3, casing 30 also comprises a rectangular parallelepiped-shaped housing 36 extending upwards from plate 31, open on the side facing drawer 7, and in turn comprising a top wall 37 supporting the top end of screw 34 in rotary manner; and a vertical rear wall 38 parallel to axes 17 and 27, and having two vertical slits 39, 40 engaged in sliding manner by respective appendixes 41, 42 extending horizontally from actuator 24 and crosswise to axis 17.

Rear wall 38, slits 39, 40, and appendixes 41, 42 together define an antirotation device 43 for preventing actuator 24 from rotating about axis 27 as it moves along axis 27.

As shown more clearly in FIG. 4, actuator 24 comprises a substantially rectangular, horizontal plate 44, from the short lateral edges of which two flat brackets 45 project downwards. Each bracket 45 is crosswise to axis 17, projects from plate 44, and is fitted, on its free end facing drawer 7, with a pin supporting a roller 46 coaxial with the other roller 46 and rotating about an axis 47 parallel to axis 17.

In a variation not shown, plate 44 has only one bracket 45 and one roller 46.

The actuator 24 also comprises a box body 48 connected to an underside surface of plate 44, housing a nut screw 49 of screw-nut screw coupling 35, and fitted integrally with appendixes 41, 42; and a tooth 50 projecting vertically downwards from plate 44, and which, as explained below, serves as an actuator for lock device 29.

As shown in FIG. 3, appendix 41 projects outwards of housing 36, and is fitted with a counter-roller 51, which rolls on the outer surface of rear wall 38 of housing 36 to discharge on housing 36 the forces exchanged between actuator 24 and drawer 7. Appendix 42 is L-shaped, and has a horizontal arm 52, which projects from the rear of housing 36, is parallel to rear wall 38, and has a substantially vertical end edge 53 with a top recess 54 and a bottom recess 55. End edge 53 of arm cooperates with a top stop microswitch 56 and a bottom stop microswitch 57, which are connected to central control unit 28, and the function of which, particularly of microswitch 57, is described below.

Each roller 46 projects laterally outwards of housing 36, is located over a respective end portion 58 of plate 31, and rolls along a track crosswise to the straight path defined by screw 34, and itself defined by an underside surface of a respective rail 59, which is integral with drawer 7, projects rearwards from wall 13 of drawer 7, slopes roughly 45° downwards with respect to wall 13, and is positioned with its free end contacting respective end portion 58 of plate 31 when drawer 7 is in the FIG. 2 closed position.

As shown in FIG. 5, lock device 29 is fitted to plate 31, and comprises a fork 60 extending upwards from a front portion of plate 31 and fitted with a right-angle rocker arm 61 that oscillates about an axis 62 parallel to axis 17; and a further'fork 63 extending upwards from a rear portion of plate 31, and fitted with a right-angle rocker arm 64 that oscillates about an axis 65 also parallel to axis 17.

Right-angle rocker arm 61 comprises a box arm 66 extending upwards from axis 62 and fitted on its free end with a pin 67, which extends, parallel to axis 62, through a window formed on the free end of arm 66 and housing a catch 68, which oscillates about the axis of pin 67, in opposition to a leaf spring 69 secured to arm 66, from a normal extracted position—in which catch 68 projects outwards of arm 66 and towards drawer 7 to define a catch on arm 66 by which to engage a striker 70 projecting rearwards from the outer surface of wall 13 of drawer 7—to a withdrawn position, in which catch 68 is housed inside arm 66.

Rocker arm 61 also comprises an arm 71 extending rearwards from axis 62 and normally held in a lowered position, contacting the topside surface of plate 31, by a spring 72 stretched between an intermediate portion of arm 66 and rear wall 38 of housing 36. When arm 71 is in the lowered position, arm 66 slopes roughly 20° rearwards, and catch 68, even if in the extracted operating position, is positioned clear of striker 70, i.e. outwards of the path travelled by striker 70 as the drawer swings about axis 17. Close to its free end, arm 71 has a curved slot 73 for connection to rocker arm 64.

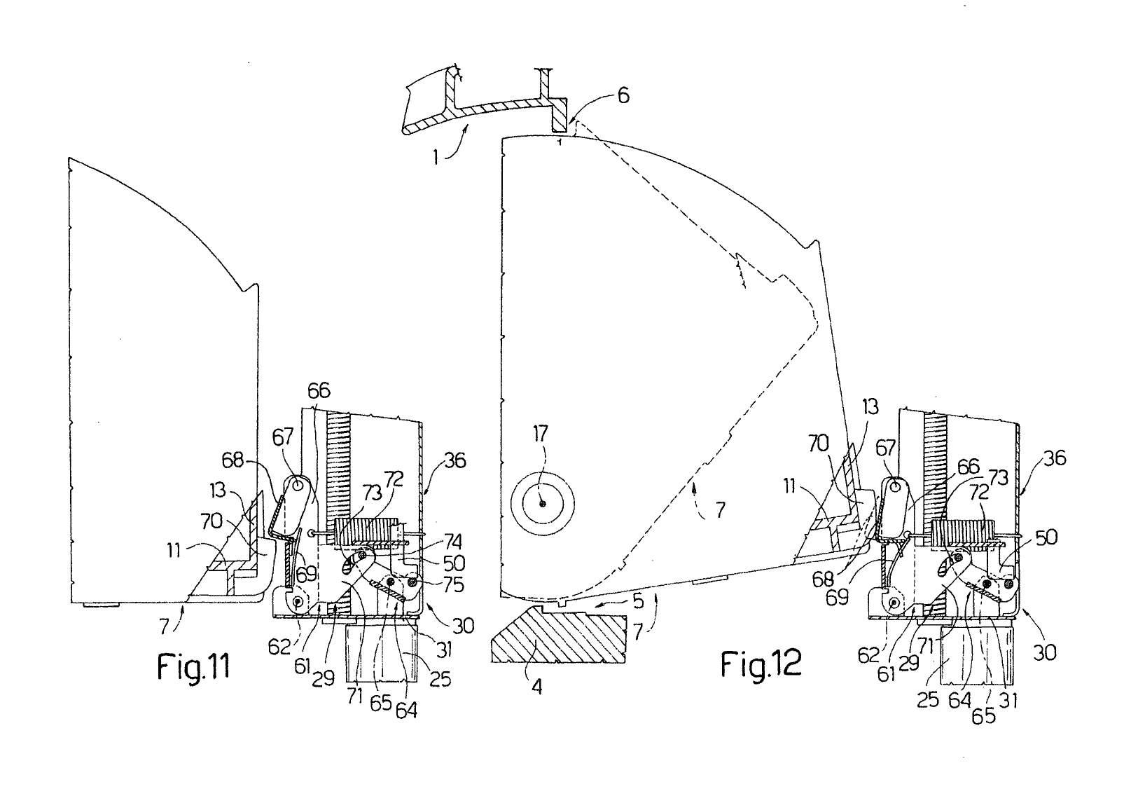

Rocker arm 64 is a double rocker arm substantially parallel to plate 31 and defined by two members on opposite sides of arm 71 and connected to each other by two pins 74, 75 parallel to axis 65, located on opposite sides of axis 65, and of which pin 74, at the front, extends through slot 73 to slide transversely along slot 73, and pin 75 is positioned vertically beneath tooth 50 (FIGS. 3, 4, 10-12) and is moved downwards by tooth 50, as described below, to lift arm 71 of plate 31, move arm 66 forwards, and move catch 68, in the extracted position, into a position of interference (FIG. 11), in which catch 68 is positioned with its bottom end directly over striker 70 and substantially contacting a top end of striker 70 when drawer 7 is in the closed position.

Operation of pickup device 9 and drawer 7 will now be described as of the FIG. 11 position, in which drawer 7 is in the closed position with walls 12, 13, 14 positioned vertically to receive a selected product 2 downwards in known manner, and is locked in this position by lock device 29. More specifically, in this position, actuator 24 is set to its lowest position, in which microswitch 57 engages top recess 54 in end edge 53 of appendix 42 of plate 44; and tooth 50 presses on pin 75 of rocker arm 64, and, by means of pin 74, keeps arm 71 of right-angle rocker arm 61 raised, and arm 66 moved towards drawer 7, so that catch 68, in the extracted position, is positioned over striker 70 to prevent drawer 7 from swinging about axis 17 into the open position.

It is important to note that, when actuator 24 is in its lowest position described above, rollers 46 are positioned adjacent to the outer surface of wall 13 of drawer 7 and a certain distance from respective rails 59.

At this point, a sensor (not shown) detects a product 2 inside drawer 7 and sends a signal to central control unit 28 (FIG. 3), which activates motor 25 to rotate screw 34 and so move actuator 24 upwards.

Powered by motor 25, actuator 24 first performs an initial movement to dislodge microswitch 57 (FIG. 3) from top recess 54 into bottom recess 55.

As shown in FIGS. 6 and 9, this initial movement lifts tooth 50 far enough to allow spring 72 to lower arm 71 of right-angle rocker arm 61, and catch 68, still in the extracted position, to move into its position of non-interference with striker 70.

This movement of lock device 29 has no effect on the position of drawer 7, which is maintained in its stable, balanced closed position by force F1 holding the ends of rails 59 in contact with respective end portions 58 of plate 31.

The initial movement of actuator 24 (FIG. 7) also moves rollers 46 closer to but not yet into contact with respective rails 59.

Microswitch 57 engaging bottom recess 55 does not stop motor 25, which continues to move actuator 24 upwards in a work movement (FIG. 6) which is arrested by arm 52 of appendix 42 engaging microswitch 56. During this work movement, rollers 46 come into contact with and exert force F2 on respective rails 59 simply by force of contact, thus lifting rails 59 and rotating drawer 7 about axis 17 into the FIGS. 6 and 9 open position. As the drawer rotates, rails 59 move away from actuator 24, with the result that rollers 46 roll along respective rails 59 from positions adjacent to wall 13 (FIG. 7) to positions close to the free ends of rails 59 (FIG. 6).

In the open position, drawer 7 is positioned with its top opening facing fully outwards, to allow product 2 to be removed from pickup compartment 8, and at the same time completely closes opening 6, as stated, to prevent break-in.

When microswitch 56 engages arm 52, central control unit 28 stops motor 25 for a given length of time, normally a few seconds, and then reverses motor 25 to perform a return movement of actuator 24, which is arrested (FIG. 7) by microswitch 57 engaging bottom recess 55 in arm 52.

During this return movement, performance of drawer 7 depends on user performance in removing product 2 from pickup compartment 8.

If the user removes product 2 within the open period, the return movement simply restores drawer 7 to the closed position. In this connection, it is important to note that drawer 7 is returned to the closed position solely by force F1, which is normally opposed by a damper (not shown), which slows down drawer 7 to allow detachment of rollers 46 from respective rails 59. Alternatively, if no damper (not shown) is provided, central control unit 28 slows motor 25, so actuator 24 simply supports drawer 7 as it moves back into the stable, balanced position, without exerting any force on drawer 7 other than a reaction force to force F1.

By the time drawer 7 comes to a stop with rails 59 contacting end portions 58 of plate 31 (FIGS. 3, 7), actuator 24 has normally completed its return movement and stopped (FIG. 7), and is positioned with microswitch 57 engaging bottom recess 55 in arm 52.

When microswitch 57 engages bottom recess 55 in arm 52, central control unit 28 stops motor 25 for a given length of time, normally about thirty seconds, after which motor 25 is started up again to perform a final movement of actuator 24, during which, with drawer 7 stationary, tooth 50 engages pin 75 of rocker arm 64 to move right-angle rocker arm 61 into the lock position (FIG. 11).

If unable to remove product 2 within the open period, the user can grip handle 16 to keep drawer 7 open. In which case, if the drawer is released before actuator 24 completes its return movement, drawer 7, once released, is rotated backwards by force F1 to move rails 59 into contact with end portions 58 of plate 31; from which point on, the closing procedure is the same as described above. Conversely, if the drawer is released after lock device 29 is activated, striker 70 (FIG. 11)—as drawer 7 is moved into the closed position by force F1—engages catch 68, backs it up in opposition to leaf spring 69, and clicks it into the lock position (FIG. 11) as drawer 7 reaches the closed position.

Whichever the case, because actuating device 23 is not connected positively to drawer 7, but simply exerts contact thrust on drawer 7 during the work movement, drawer 7, even it is already closed, can be opened manually by the user, providing lock device 29 has not yet been activated.

1. A method of dispensing products in a product vending machine, the method comprising the steps of:
providing a drawer defining a pickup compartment for a selected product and movable, through an opening in an outer wall of the vending machine, between a closed position, in which the pickup compartment is adapted to receive said product, and an open position, in which the pickup compartment is accessible from outside the vending machine; the closed position being a stable, balanced position achieved by applying a first force to the drawer;
setting the drawer to the closed position;
providing actuating means for the drawer, and a reversible motor to operate the actuating means;
activating the motor to impart to the actuating means a work movement, in which the actuating means exert on the drawer, by simply contacting the drawer, a second force in opposition to, and greater than, the first force to impart to the drawer a first movement from said closed to said open position; and
reversing the motor to impart to the actuating means a return movement to enable the drawer to perform a second movement into the closed position under the effect of the first force.

2. A method as claimed in claim 1, wherein the drawer, in the closed position, is normally locked in position by locking means; the method comprising the further steps of releasing the locking means before imparting the first movement to the drawer, and locking the locking means during the return movement.

3. A method as claimed in claim 2, wherein the locking means are released and locked by the actuating means.

4. A method as claimed in claim 2, wherein said work movement and said return movement are longer than the first and second movement respectively; the work movement and the return movement comprising an initial movement and a final movement respectively, during which the actuating means are detached from the drawer and engage the locking means to perform said releasing step and said locking step respectively.

5. A method as claimed in claim 1, wherein the drawer, in the closed position, is positioned contacting stop means; the drawer being detached from the stop means by the actuating means at an intermediate point in the work movement.

6. A method as claimed in claim 4, wherein the actuating means are operated by the motor to perform the initial movement and the work movement in one continuous, uninterrupted movement.

7. A method as claimed in claim 4, wherein the actuating means are operated by the motor to perform the return movement and the final movement in successive stages separated by a time interval.

8. A method as claimed in claim 1, wherein the movements of the drawer are oscillations about a fixed axis.

9. A method as claimed in claim 8, wherein the drawer performs said oscillations about the fixed axis through said opening.

10. A method as claimed in claim 1, wherein the actuating means are mounted for movement along a straight path.

11. A method as claimed in claims 8 and 10, wherein the straight path extends crosswise to the fixed axis.

12. A method as claimed in claim 11, wherein the actuating means comprise at least one roller movable along the straight path, and the drawer comprises a rail, an underside surface of which defines a track substantially crosswise to the straight path, and along which the roller runs; and wherein the actuating means, in the course of the work movement, bring the roller into contact with the track to exert said second force on the drawer, and cause the roller to roll along the track from a first point on the track, located adjacent to the drawer, to a second point on the track, located further than the first point from the drawer.

13. A vending machine for products, the vending machine comprising:
a cabinet having an outer wall with an opening;
a pickup device comprising a drawer, which defines a pickup compartment for receiving a selected product, and is movable through the opening between a closed position to receive the selected product, and an open position enabling removal of the selected product from the outside; the closed position being a stable, balanced position achieved by applying a first force to the drawer;
wherein the pickup device further comprises a reversible motor and actuating means operable by the motor to perform a work movement to exert on the drawer, simply by contact, a second force in opposition to and greater than the first force, and to impart to the drawer a first movement from the closed position to the open position through said opening; and to perform a return movement to enable the drawer to perform a second movement through the opening into the closed position under the effect of the first force.

14. A vending machine as claimed in claim 13, wherein the pickup device also comprises locking means for locking the drawer in the closed position, and activating means for activating the locking means; the locking means being movable between a rest position of non-interference with the drawer, and a lock position locking the drawer in the closed position; and the activating means being movable with respect to the locking means to release the locking means before the drawer performs the first movement, and to lock the locking means during the return movement.

15. A vending machine as claimed in claim 14, wherein the activating means are carried by the actuating means.

16. A vending machine as claimed in claim 14, wherein said work movement and said return movement are longer than the first and second movement respectively; the work movement and the return movement comprising an initial movement and a final movement respectively, during which the actuating means are detached from the drawer, and said activating means engage the locking means to release and lock the drawer respectively.

17. A vending machine as claimed in claim 13, wherein the pickup device also comprises fixed stop means for arresting the drawer in the closed position.

18. A vending machine as claimed in claim 13, wherein the drawer is mounted to perform said movements by oscillating about a fixed axis.

19. A vending machine as claimed in claim 18, wherein the drawer is mounted to perform said movements through said opening.

20. A vending machine as claimed in claim 13, wherein the actuating means are mounted for being moved by the motor along a given path.

21. A vending machine as claimed in claim 18, wherein said path is a straight path extending crosswise to the fixed axis.

22. A vending machine as claimed in claim 20, wherein the actuating means comprise at least one roller movable along said path, and the drawer comprises a rail, an underside surface of which defines a track substantially crosswise to said path; during at least part of the work movement of the actuating means, the roller rolling from a first point on the track, located adjacent to the drawer, to a second point on the track, located further than the first point from the drawer, to exert said second force on the drawer.

23. A vending machine as claimed in claim 13, wherein the pickup device comprises a fixed casings), and an actuating device fitted to the casing; the actuating device comprising said motor, said actuating means, and a transmission interposed between the motor and the actuating means; the motor and the transmission being fixed with respect to the casing; the actuating means comprising an actuator movable with respect to the casing along a given path; and locking means being provided to lock the drawer with respect to the casing.

24. A vending machine as claimed in claim 23, wherein the transmission comprises a screw powered by the motor and connected to the actuator by a screw-nut screw coupling.

25. A vending machine as claimed in claim 23, wherein the locking means comprise a rocker arm fitted to the casing and in turn comprising a first and a second arm, the first arm being movable towards the drawer in opposition to first elastic means; a catch fitted to the first arm and movable, with respect to the first arm and by second elastic means, from a withdrawn position, in which the catch is housed inside the first arm, to an extracted position; striker means fitted to the drawer and engaged by the catch in the extracted position to lock the drawer in the closed position; and transmission means connected to the second arm and operated by the actuator to move the first arm towards the drawer in opposition to the first elastic means.
